(19) United States
(12) Patent Application Publication
(10) Pub. No.: US 2011/0145312 A1
(43) Pub. Date: Jun. 16, 2011

(54) SERVER ARCHITECTURE FOR MULTI-CORE SYSTEMS

(75) Inventors: Kodumudi Somasundaram Gokulakannan, Broadview Heights, OH (US); Sridharan Venkatesan, Salem (IN)

(73) Assignee: Electron Database Corporation

(21) Appl. No.: 13/057,004

(22) PCT Filed: Apr. 14, 2010
(86) PCT No.: PCT/SG10/00149

§ 371 Date: Feb. 1, 2011

(30) Foreign Application Priority Data
Apr. 14, 2009 (SG) 200902512-3

(51) Int. Cl. G06F 15/16

(52) U.S. Cl. 709/201

(57) ABSTRACT

A server architecture is disclosed for concurrent information processing in a server system on a multi-core processor environment. In the general embodiment, it includes simultaneous processing requests comprising multiple classes of queries and/or executing transactions in an application server and/or database server. The method includes making said requests in a Total-Async pattern, structuring the requests with hash values to enable similar requests to be grouped together, grouping similar requests in a group session, executing the requests in said group session. Our proposed architecture also minimizes thread-switching overhead by exploiting inherent parallelism in the inflowing requests. The threads and requests are de-coupled and hence any lock request only makes the execution threads to take up another request instead of waiting till the lock is acquired. As such, threads inside the database process never go into sleeping/waiting mode and system resources are utilised more efficiently.

### TECHNICAL FIELD

The invention discloses a software processing architecture for an application server or database server running on multi-core or multi-processor machines with cache-coherent non-uniform memory access (cc-NUMA) and SMP architectures, particularly favouring the former. More specifically, it relates to the processing, threading and locking in server software for handling concurrent requests such that performance and scalability are improved.

### BACKGROUND ART

Current server software architectures may be categorized into either one of the following two types in endeavouring to improve on performance and scalability. All the existing database applications in the market such as Oracle, SQL Server, DB2, PostgreSQL (object RDBMS), MySQL (RDBMS) and Firebird (database server) use one of the following two architectures, i.e. (a) a process or thread per user session; and (b) a process pool or thread pool for handling all the users sessions.

(a) Process or thread per user session is more commonly used in database systems. FIG. 1 (Prior Art) shows a schematic block diagram of a model of such process/thread per session architecture. A process or thread is spawned for every user login and which will last until the user has logged out. All requests from that user are undertaken in the spawned process or thread. This category of architecture has some disadvantages, however. For one, process creation is not resource-efficient and costly, especially in online transaction processing (OLTP) systems. When a number of users are logged in, the system would be running a corresponding number of processes and hence a lot of process switching overhead is required by system resources compare to that actually employed to perform useful work.

To ameliorate these limitations, a connection pool is typically provided at the application server level, i.e. a cache of database connections is maintained by the database so that the connections can be reused when the system needs to attend to future requests for data. With this technique, a user's OLTP need not be executed by the same process or thread every time but the result is that data cannot be cached in memory at the database level between two requests in a particular session. The data can still be cached in a memory area, accessible to all the sessions, but then it introduces the synchronization overheads to access/modify the data. As an example, if the user keeps sending the same query repeatedly, it might be reasonable for the system to store the query plan and any relevant data in his own session memory, which can be accessed without any synchronization. However, such memory area (unique to a session) is not available at the database server level, since each request might go to a different process or thread.

Server architecture might be designed such that data is stored at the application server level memory. However, this might result in too much caching at the application server level resulting in a considerable garbage collection overhead. Prior art method for avoiding heap management or garbage collection overhead is by pre-allocating pools of memory and using a custom, lightweight scheme for allocation/de-allocation. However efficient the garbage collection algorithm is, it is designed only for short-lived small objects and not for persistent information or long-lived caches. Application server garbage collection is designed with short lived objects in mind. If such a heap is being used as a cache for database connection, then the overhead will be considerable. Moreover, some of the data-like query plans are known to be very complex to be cached at the application server level. These query plans are also known as “query execution plan”, i.e. a set of steps used to access or modify information in an SQL RDBMS. The plan basically tells whether to do index scan or full table scan to get the query results.

Another disadvantage of the connection pool at the application server end is that the full utility of temporary tables cannot be exploited. Any insert/update in the database will result in the recovery log overhead. This overhead is incurred to safeguard data integrity so that when the database crashes, the data can be recovered. However, for temporary cached data discussed above, logging for crash recovery is not required and it is not necessary to provide for the typical robust log file structure to redundantly record the database update operation. In fact, for our purpose ISO standards approve a less robust temporary table structure which need not be recovered after the database crash. Nevertheless, the temporary table will become tied up to the database server process in this case and the connection pool does not guarantee to allocate the requests from the same user to the same database server process or thread. Hence, any temporary table activity is restricted to be used within a request and cannot be spawned across requests.

From the above discussion on the process or thread per user session, it is difficult to correlate actual system resources to this kind of architecture. As every user login creates a process or thread, the number of execution units is not under the control of the database architecture and hence might result in inefficient utilization of the system resources in delivering the optimal output. One might try to estimate the number of concurrent users in order to produce a well-balanced system, but accurate estimation of concurrency depends a lot on heuristics and user behaviour which might vary from time to time.

(b) Process pool or thread pool handling all user sessions will now be discussed. This architectural alternative, which is represented diagrammatically in FIG. 2 (Prior Art), is based on the Half-Sync/Half-Async design pattern which is commonly implemented in application servers and supported in some database servers. In such architecture, a pool of threads or processes takes requests from the queue one by one and executes each of them to completion. This server architecture might also needs a pool of threads or processes to communicate with the clients. Some of the major disadvantages of this database server architecture are discussed below.

If there are a few long-running queries, they will occupy the threads or processes for a long time, making them unavailable for the small queries. Moreover, if the thread pool or process pool was created with a predetermined maximum number of processing units in mind, then the processing units may be under-utilized during the I/O service time of the requests. This disadvantage is especially true for the database server architecture where a lot of I/O is involved.

It is also difficult to build in an option to increase the hit ratio on the data cache and instruction cache whenever such opportunity presents itself in such architecture. Furthermore, the concurrency requirement in such architecture is usually handled in the same way as in the previous discussed architecture. Hence there is a chance that all these shared servers might be waiting to acquire a lock or enter a monitor and hence the overall system resources might be under-utilized.

Some of the prior art known to us regarding multithread caching architectures are U.S. Pat. No. 6,665,704 (Sun Microsystems), U.S. Pat. No. 6,941,379 (IBM Corp.), U.S. Pat. No. 7,155,727 (Sun Microsystems), U.S. Pat. No. 7,340,730 (Sun Microsystems), U.S. Pat. No. 7,412,568 (Intel Corp.) and U.S. Pat. No. 7,333,921 (Taylor), while a representative number of published U.S. patent applications include US-2001/0049747 (Namezero.com), US-2006/0080450 (IBM Corp.), and US-2006/0271852 (Lloyd).

### SUMMARY OF DISCLOSURE

### Definitions

In this specification,

“server software”, “server program” or simply “server” each has meaning that includes software system which is run (either as an application server or database server or both) to provide services to other computer programs or users, rather the computer or hardware server (e.g. “blade server”, “rack-mounted server”) unless it is so defined in context;

“concurrent processing” or “concurrency” has meaning that includes a software environment or architecture for server software in which multiple classes of queries and/or transactions are executable or executed simultaneously;

“request” has meaning that includes a command, instruction or query from a user to the server”;

“Request Handler” is a thread, which executes the user request. Whenever a page needs to get locked, the Request Handler acquires the lock so that the user request need not be concerned about locks. The Request Handlers are combined into Handler groups and a mapping gets created between the database tables and Handler groups, that favours the ccNUMA systems. Whenever there is a I/O to be performed in the request, it is forwarded to the I/O Handler, the thread that does the I/O.

“I/O Handler” is a thread that takes care of the I/O part of any request. It is expected to occupy the processor for very short periods of time to initiate an I/O, leaving the bulk of the rest of the processor time to the Request Handler. Since the I/O service time is usually in milli-seconds and today's processors are working in GHz, we expect the worst case thread switching frequency at 10⁶:1. Usually there is a I/O Handler per Request Handler, to take care of its I/O Requests.

“session” has meaning that includes a process or situation whereby a plurality of requests are grouped to facilitate execution in the same context. Sessions are created when the user logs in. This might end up creating a process/thread in certain architectures. It also serves the purpose of security, in which after the user provides a valid UserID and password, a session is created with a session ID and is used for further communication with the server.

The proposed architecture is a variation of the thread pool/process pool architecture discussed above. Firstly, it tries to group requests of similar kind and tries to execute them together. For example, consider a Full table scan request. Say there are two queries:

Query 1: Select*from employees_table where name like ‘a %’.

Query 2: Select*from employees_table where name like ‘b %’.

Both the queries have some common operations—fetching the record and obtaining the value of the name field out of it. Only the condition to be applied differs. Current architectures run these two requests as separate requests.

Our proposed architecture groups these requests into one so that the resultant request will do the task of fetching the record and fetching the name field out of it only once, after which it will try to segregate the requests based on their respective query criteria and forward to the appropriate Client (from where the query originated).

Secondly, we don't execute one request at one go. Instead a request is split into multiple sync-points (say Syncpoint A, Syncpoint B, etc.). This is done because there might be more grouping opportunities between any two sync points. For example, multiple requests might have the same operation between Syncpoint A and Syncpoint B and hence the operation can be performed only once.

Generally, our proposed invention concerns novel cache-conscious and multi-core conscious server architecture by fully exploiting concurrency in handling similar requests. Our proposed architecture also minimizes thread-switching overhead by exploiting inherent parallelism in the inflowing requests. This is achieved by grouping together requests that have similar tasks and executing them only once. This involves integrating a value to the set of information or query structure of the request in substantially Asynchronous manner. Preferably, the requests are processed in Complete-Async or Total-Async or Full-Async way or manner. Concurrent requests having common tasks may be grouped together for single execution. In this pattern, threads and requests are totally de-coupled from each other and hence any lock request only makes the execution thread to queue the locking request (if lock cannot be obtained) and take up another request instead of waiting till the lock is acquired. As such, threads inside the database process never go into sleeping/waiting mode and system resources are utilised more efficiently.

By minimizing lock, processing or threading of server requests across multiple classes of requests are enhanced. This is achieved by switching the requests to the threads holding the shared data and enabling the current threads to continue processing another request. Say, if Request_r1 in Thread A wants to read a page, being held by Thread B; Thread A simply queues the request under Thread B and proceeds on to executing some other request in its queue.

Since the request being executed is split into multiple sync-points and a request can only be possibly associated with a thread only between the two sync-points, we avoid the case of one request hogging a thread for extended period of time. The request can even get disconnected with the thread in-between two sync-points, whenever there is a lock/page request and it is not available to be acquired. In this case, the request gets transferred to the thread owning the lock/page.

The general embodiment of our method for concurrent information processing in a server system on a multi-core processor caching environment includes simultaneously processing requests comprising multiple classes of queries and/or executing transactions in at least one of an application server and a database server. Our method comprises of:
(a) making said requests in substantially asynchronous manner, preferably in Full or Complete-Asynchronous way;
(b) maintaining structure of said requests with information to enable similar requests to be grouped together;
(c) grouping said similar requests in group session; and
(d) executing said requests in said group session.

This group session is therefore short lived since it exists only for execution of the common tasks and delivering the results to the user sessions. Preferably, the information or query structure of the requests is maintained such that a plurality of concurrent requests is identifiable by their respective tasks and grouped according to their similarity of task category. One aspect of the information or query structure of the requests is to assign the structure with similar hash value according to similar task category of the request. Upon being grouped according to similarity of tasks, the grouped requests may be executable as a single request. The grouped requests may further preferably be maintained as grouping session for execution in a database server or application server.

A second aspect of our method provides for the request to be switchable between threads, based on the current holder of the shared data required by the request. Preferably, our method provides for the information or query structure of the requests to be managed on the basis of thread-specific storage structures providing concurrent access to shared data among concurrent data updates.

A third aspect of our method for concurrent information processing involves for the processing in Full or Complete-Asynchronous way, including enabling the requests to pause and restart on demand. In the proposed architecture, a request is divided into multiple syncpoints and the request is coupled to the thread only between two sync-points. Even between two sync-points, the request might get de-coupled from the thread executing it, in case there is a page request/Lock request.

A fourth aspect of our invention provides for the incoming requests to be handled by Request Handlers and the separate classes of threads to be embodied as I/O handlers, taking care of both the network and/or disk I/O. Preferably, one I/O handler runs for each Request Handler and for flushing data as required for secondary storage. A new request object may preferably be created for the Request Handler to process as a single request for the grouped requests. The request handler will not be waiting on any I/O, hence the processing power is efficiently utilized.

In a fifth aspect, a plurality of sync points for each of the requests in the group may be provided prior to their completion. Preferably, all the requests in the group are taken to a particular synchronisation point prior before proceeding therefrom and carry forward all of said requests to next synchronization point.

A sixth aspect of our method provides for each processor to be bound to a thread group with each core hosting two threads—a thread each for request and I/O handlers. Preferably, each thread group operates on a subset of tables depending on the workload on the database and only the joins access data from other tables.

In the event a locking request is made, an execution thread shall put up the locking request for queuing without waiting for lock to be acquired and shall then take up another request to be processed. The request from the first thread may be switched to a second thread holding shared data, thus enabling the first thread to continue processing the other request.

When a first thread in possession of its own operating page receives a request to operate on the operating page from a second thread, the request may be enqueued in the first thread's operating page queue. Preferably, multiple requests from second and subsequent threads are processed in the same manner with each of the multiple requests being so enqueued in the first thread's operating page queue, favourably in the same core.

In a preferred aspect, when the thread or Request Handler takes a lock on the operating pages and the requests enqueued on the page, the thread preferably groups the enqueued requests according to similarity of tasks, whenever possible, for group execution. More preferably, the grouped requests are executed as a single request or a series of request in a Grouped Executor Session. A specific embodiment of our method involves:
(i) a first Request Handler takes a request from Request Handler Group Queue to examine it with a view to execute said request;
(ii) if said request's execution requires access to data or information that is on a particular page of a table, the header of that page is first examined;
(iii) if said particular page is already in possession of a second Request Handler, then said request is queued under one of the queues of said second Request Handler whereby;
(iv) if the page is marked as Operating Page, then said request is queued under Operating Page Queue of said second Request Handler, otherwise said request is queued under Other Page Request Queue; and
(v) said first Request Handler continues by picking up a new request to be examined with a view to execute it.

The aforesaid features would particularly benefit cc-NUMA architecture systems, since the relevant data will most probably get loaded into the local memory and not the remote memory, increasing the speed of memory access. For SMP systems, we will have only one thread group and that thread group will have access to all the tables and hence there is no special advantage for it.

### LIST OF ACCOMPANYING DRAWINGS

Other advantages and features of our invention may become more apparent upon perusal of the following detailed description when taken in conjunction with the following drawings which collectively compare the prior art against non-limiting exemplary, specific or preferred embodiments of our method.

FIG. 1 (Prior Art) shows a schematic block diagram of a prior art model of a process/thread per session architecture.

FIG. 2 (Prior Art) illustrates a schematic block diagram of another prior art model of a process/thread pool for all sessions architecture.

FIG. 3 depicts an embodiment of our proposed architecture which processing of a plurality of requests at the database server end shown in a schematic block diagram.

FIG. 4 exemplifies another embodiment of our proposed architecture wherein a plurality of sessions are handled by a process/thread pool in multi-core processor environment shown in schematic block diagram.

FIG. 5 shows a block diagram of our Request Handler mapping implementable in a typical NUMA hardware configuration comprising a quad-processor quad-core system.

FIG. 6 illustrates an example of a page locking flow enabling the enqueuing and execution of requests in our invention.

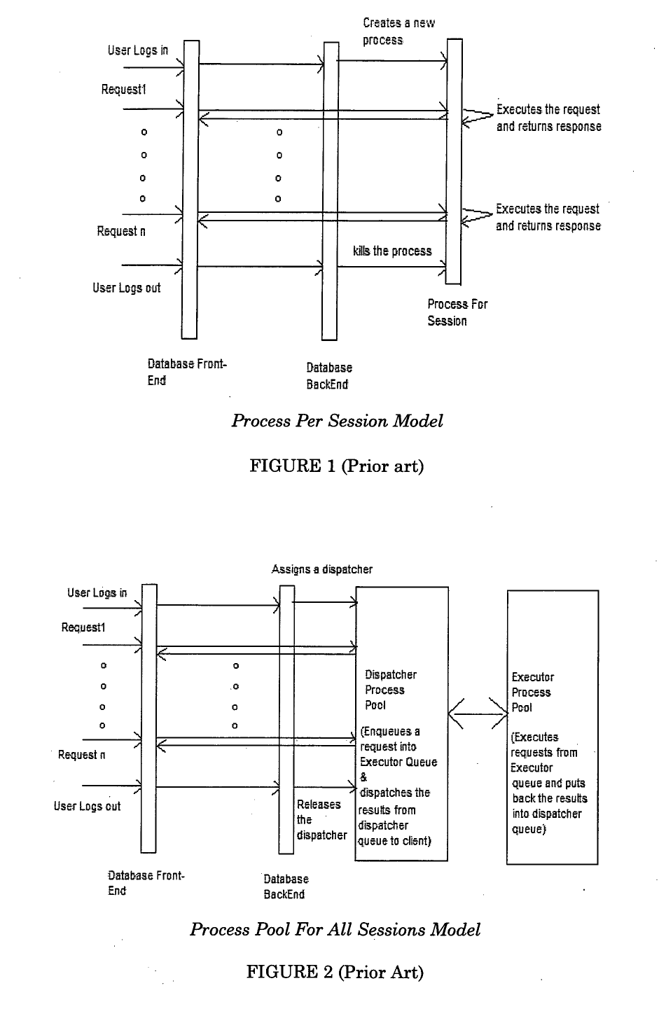

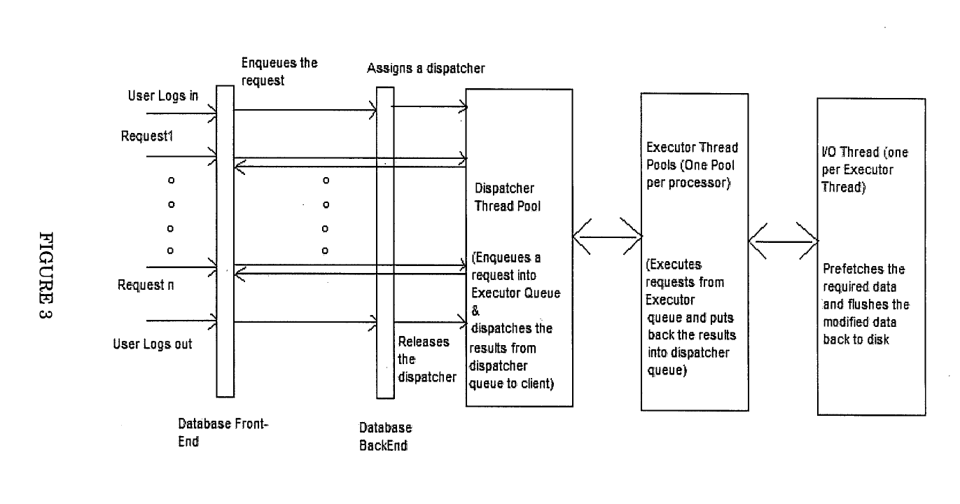

### DETAILED DESCRIPTION OF SPECIFIC EMBODIMENTS

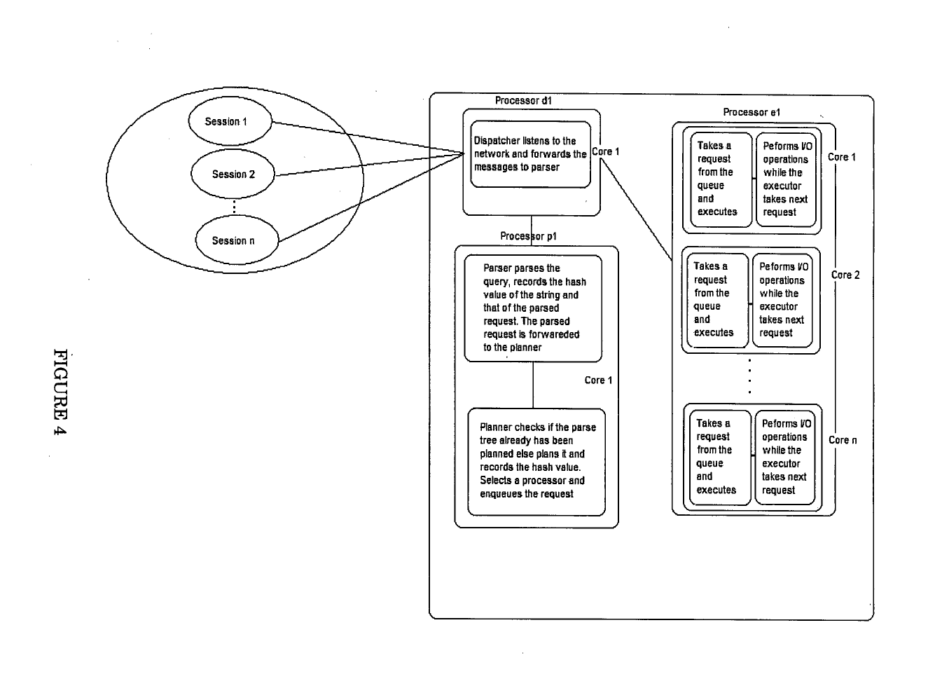

With collective reference to FIG. 3 and FIG. 4, the general embodiment of our invention may be described as being comprised in a method for concurrent information processing in a server system on a multi-core processor caching environment wherein the information processing includes simultaneous processing requests comprising multiple classes of queries and/or executing transactions in at least one of an application server and a database server.

Underlying our method is to make the requests in a substantially asynchronous manner, preferably a total, full or completely asynchronous way, including the capability to pause and restart the request on demand. This may include modifications of the conventional Half-Sync/Half-Async pattern applicable for databases and application servers such that there is no synchronous part in the execution of a query. It should be noted, nevertheless, that our architecture will work with substantially async manner of processing such as where large objects, e.g. multimedia files, are stored and accessed in which case the complete async way is not possible or undesirable.

In handling large objects, the I/O Handler may not be able to load completely the object into memory in order for the request handler to process it. Say, if a large object is of the size of 10 GB, then loading it completely might not be feasible in a system with only 8 GB of memory. It may even turn out to be counter-productive, as attempt to load it would flush out other often accessed pages already loaded in memory. Hence, streaming the large objects synchronously (with possible I/O waits) by the Request Handler is a possible solution for reading them. Nevertheless, our proposed method will work under such circumstances in a substantially asynchronous, i.e. we will first prefetch a considerable portion from the beginning of the object (say, 100 kb) with the I/O Handler. We would expect that by the time we finished processing the first 100 kb, subsequent portions of the file (say, another 100 kb) might get loaded because of the prefetching mechanisms employed such as that in a typical file streaming operation by the operating system and hardware processor.

Broadly defined, our method comprises the steps of (a) making said requests in substantially asynchronous way, including a totally asynchronous way; (b) calculating a hash on the request query's string with information to enable similar requests to be grouped together; (c) grouping said similar requests in group session (including whereby a group session is formed by putting all the requests with the same hash value inside a session object) and (d) executing said requests in said group session.

Current database/application server architectures do not support the grouped execution concept as disclosed here. Due to the changes that we introduce herein, the proposed architecture is substantially asynchronous and preferably a complete asynchronous architecture with no synchronous task; in contrast, the conventional Half-Sync and Half-Async architecture puts the long running tasks under sync thread group and short running system tasks (like network I/O) into asynchronous tasks. It might be said that dynamic grouping based on the business transaction to be executed is not accomplished in the current architectures, leaving aside the static grouping in Half-Sync Half-Async pattern. Moreover the kind of grouping which we refer here is creating a new request object, which is a collection of user requests that can be grouped. In Half-Sync Half-Async, the requests are executed separately, even though collected in a queue.

In contrast, in conventional architecture employing Half-sync/Half-Async pattern, the threads and session are de-coupled. Requests from the same session might go to different threads. But one request is associated with a query executing thread/process until the completion of the synchronous part of the request execution, which comprises most of the request. The ability to pause and restart a request cannot be supported by the existing architectures because, in the current architectures, the requests lock the shared resources and putting them to pause makes the resources unavailable. In the proposed architecture, the resources are held by threads and the requests are totally decoupled from the thread; thus, pausing a request would only affect the particular request and would have no impact on the shared resources.

A salient feature of our method includes providing the information or query structure of the requests to be maintained such that a plurality of concurrent requests is identifiable by their respective tasks and grouped according to their similarity of task category. One way to structure the requests is to assign each of them with a hash value which reflect the task similarity of the request. A preferred embodiment is to assign a similar hash value to the request's query or information structure so that similar hash value is accorded to similar category of tasks. With this feature, requests having similar tasks may be grouped and may be executed as a single request in a Grouped Executor session. Our Executor session corresponds to the concept of session in any of the servers today and it is capable of executing a series of requests. Only the requests are assigned with hash value for grouping and not the request handlers, being the threads inside the thread group, which execute the requests. Grouped Executor Session is a Session created for executing the grouped requests and deleted after the execution.

The request is switchable between threads, based on the current holder of the shared data required by the request. Accordingly, the information or query structure of the requests may be managed on the basis of thread-specific storage, structures while providing concurrent access to shared data among concurrent data updates. A preferably, typical situation of our method comprises a single process with fixed number of threads in different classes. As the requests are grouped as a collection of similar requests, it is preferred that a new request object be created so that it may be seen by the Request Handler as a single request and process it accordingly. The incoming requests may preferably be handled by the Request Handlers and the separate classes of threads may be embodied as I/O handlers, taking care of both the network and/or disk I/O. The Request Handler can keep executing tasks by delegating any I/O to the I/O handler, thereby reducing performance declines caused by waiting.

The Request Handler count can be decided depending on the number of processing units available and the I/O handler count can be decided based on the amount of parallelism the data storage can support. In a specific embodiment, our method may provide for one I/O handler running for each Request Handler and for flushing data as required for secondary storage. It may prefetch the data needed for the Request Handler and also takes care of flushing the data created by the Request Handler to the secondary storage.

Another aspect of our method involves providing for a plurality of synchronization points for each of the requests in the group prior to their completion. Compare to the disadvantages of the Thread Pool/Process pool approach discussed in the Prior Art section wherein long queries can hog the threads for a long time our proposed architecture solves this problem by splitting a long request into multiple sync-points and it is paused and restarted between sync-points. Because of this feature, a long request cannot hog the thread for a long time. By dividing the request into multiple-sync points, we may associate a user request with multiple threads and multiple user requests are grouped and associated with a single thread. This level of de-coupling is not present in the current architectures and it avoids a request hogging the thread for long time.

This feature involves taking all the requests in the group to a predetermined sync point prior before proceeding therefrom and carry forward all of said requests to next sync point. When we divide the requests into multiple sync-points, there is more opportunity to group requests. By grouping requests we mean grouping the requests which operate on the same data with different operations. Since all the requests operate on the same data, the request processing is highly cache-efficient. Say you have a join request between tables ‘A’ and ‘B’ and another between tables ‘A’ and ‘C’. Say both of them involve scanning of ‘A’ first. By making the above two requests with two sync-points (Sync-point 1: Scanning Table ‘A’ and SyncPoint 2: Scanning the other table) we have a means to group-execute the Syncpoint 1 from both the requests. We attribute this feature to render the execution of our method to become highly data cache-conscious, since we are going to have one copy of Table ‘A’ rows or tuples, to be possibly processed, being utilized for two requests. In the current architectures, each request will have its own copy of the data from Table A, which results in duplication, reducing the cache efficiency to store more data.

Specific elements or embodiments of our method at each of the processor level, application server end and database server end may now be described in the following. At the microprocessor level, our method provides for each processor to be bound to a thread group with each core hosting two threads, i.e. one thread for each of the Request Handlers and I/O handlers. The I/O handlers and Request Handlers usually operate on the same data and hence cache thrashing is avoided. The grouped requests may be maintained as a single grouping session for execution in a database server or application server.

For application server requests, this can be based on the business transaction that is required to be done and for a database server, this can be based on the query plan that is generated. The hash value, previously described, serves to group requests which are similar, and any common tasks of the concurrent requests, if executed by the same thread exploits the cache to a greater extent.

Data Cache consciousness greatly impacts performance in databases, but application servers are not as sensitive. Each thread will own a page (operating page) and if any other thread wants to operate on the same page, it will enqueue the request in the operating page queue of the thread holding the page. This makes sure that whenever there is a need to operate on a page simultaneously by multiple requests, the requests are moved to the same thread and hence to the same core. This would result in most of the data being operated from L1 cache of the processor.

The multi version concurrency (MVCC) is usually used to resolve concurrency bottlenecks at the record level but the pages are usually accessed with shared or exclusive locks. There typically exists a buffer/page manager infrastructure in all the databases, from where the user sessions request for locks. The lock is provided to the requesting sessions by the Page manager or Buffer manager which internally employs any one of common synchronization mechanisms. It provides each user connected to the database with a “snapshot” of the database for that person to work with. Any changes made will not be seen by other users of the database until the transaction has been committed. So the processes which are waiting for locks are idle till the lock it is interested in is released.

However, this conventional technique also leads to thundering herd problem when the locks are released. In the proposed model, the request simply gets switched to the thread-carrying the data and thus avoiding most of the problems associated with traditional locking. In conventional architectures, say request A locks a page with exclusive lock for insert/update. If another request tries to lock the same page for shared lock/exclusive lock, it goes into waiting mode. In the proposed architecture, threads/Handlers take the lock on pages and the requests who want to work with the page, enqueue themselves in the thread's queue. The thread executes them one by one by grouping them. This is cache-friendly, since the thread operates on the same page again and again. In addition, requests to operate on the data on the same page also provide an opportunity to increase cache utilization factor for that page.

Another aspect of our method in respect of the database server end is that each thread group operates on a subset of tables depending on the workload on the database and only the joins access data from other tables. Since each thread group operate on a subset of entire set of tables, the content from a particular table gets mostly cached at that portion of memory, which is local to that thread group. In ccNUMA architectures, having the required data in local memory means faster memory access. This feature of our method is thus particularly favourable to the ccNUMA systems.

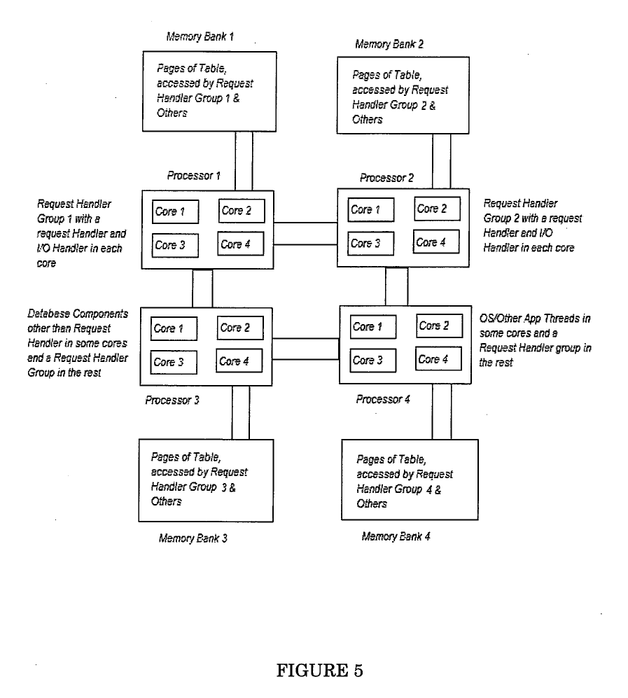

As an example, we refer to FIG. 5 in which a block diagram of our Request Handler mapping implementable in a typical NUMA hardware configuration which system comprises a quad-processor quad-core system shown to be running different typical tasks distributed over the 4 processors and their memories. Each of the four quad-core processor shares in its respective Memory Banks the pages of table that are accessible by Request Handler Group of the respective processor as well as that of other processors. Each of the processor may contain some Request Handler and I/O Handler Threads of a Request Handler Group. Due to affinity between the tables and Request Handler Group, the pages to be accessed by a Request Handler are most likely to be found in the local memory its resident core.

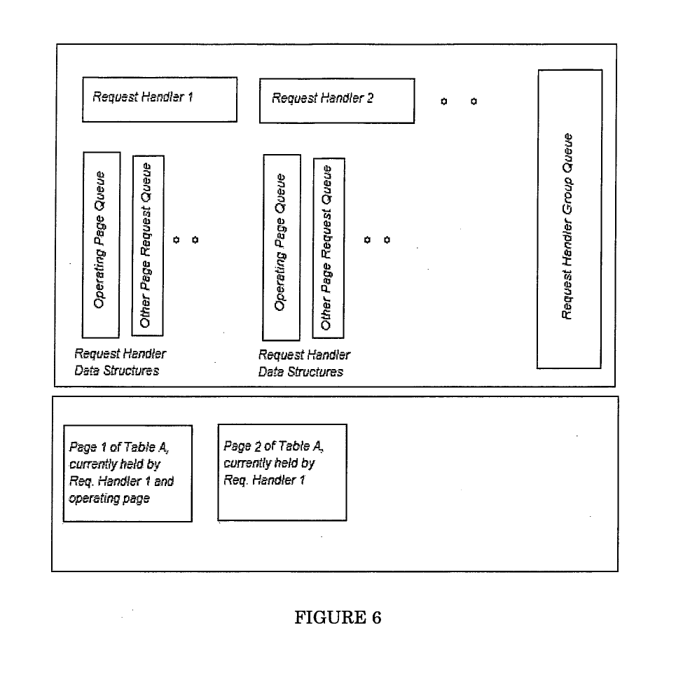

FIG. 6 illustrates an example of a page locking flow enabling the enqueuing and execution of requests in our invention which we shall now describe. A plurality of Request Handlers may operate in series although our diagram only shows the first two Request Handlers. Each Request Handler will take a request from the Request Handler Group Queue to examine it with a view to execute it. If the request's execution requires access to data or information that is on a particular page of a table, then the header of that page is first examined.

If the particular page is already in possession of another request handler, say Request Handler 1, then the request is queued under one of the queues of the Request Handler 1, depending on the nature of the page. If the page is marked as Operating Page, then the request is queued under the “Operating Page Queue” of the Request Handler 1. Otherwise, it is queued under “Other Page Request Queue”. It should be noted that there can only be one Operating Page per Request Handler, i.e. the page that is currently being acted upon by the Request Handler.

Continuing with the above example, amongst the requests enqueued in the Request Handler Group Queue, say, Request A is picked up by the Request Handler in its attempt to execute it. In the attempt, it is found that Request A is a request, say, for update of the page 1 of Table A. The Request Handler would then proceed to examine the header of the page of interest and lead it to find out that it may be found in the Operating page of Request Handler 1. To proceed, our methodology calls for Request Handler 2 to enqueue Request A under Operating Page Queue of the Request Handler 1 and picks up the next request from the Request Handler Group Queue and continues with its execution.

The industrial applicability of our invention may be stated in form of the advantages of our method for concurrently processing information in a server system on a multi-core processor environment in the following.
The I/O handler takes a count of pages processed from each requests and increments it before doing an I/O on its behalf. A request cannot hog the thread for extended period of time. So, once a request gets executed for x pages, it should be forcibly put into sleep mode to avoid hogging the CPU. Instead, the task gets re-queued behind the newly queued requests. This thus stops a request from repeatedly occupying the CPU continuously for an extended period.
The threads and requests are totally de-coupled by virtue of the Total-Async pattern and hence any lock request would make the execution threads to take up another request instead of waiting till the lock is acquired.
Since the threads inside the database process never go into sleeping or waiting mode as long as there are requests to be served, the system resources are utilized very efficiently.
Requests to operate on the data in same page provide an opportunity to increase the cache utilization factor for that page.
Since I/O is handled by the separate set of threads called I/O handlers, the request handler can keep executing tasks delegating any I/O to the I/O handler thereby mitigating the performance degradation caused by waiting. The request handler count can be decided depending on the number of processing units and the I/O handler count can be decided based on the amount of parallelism the data storage can support.

Apart from the general embodiment of our method for concurrently processing information in a server system on a multi-core processor caching, and the specific embodiments described above, it would be obvious to a skilled person that many aspects of our invention may be presented in other variations, substitution or modifications thereof without departing from the essence and working principles of the invention. Such variations are to be considered as falling within the letter and scope of the following claims.

1. A method for concurrent information processing in a server system on a multi-core processor environment, said information processing includes simultaneous processing requests comprising multiple classes of queries and/or executing transactions in at least one of an application server and a database server, wherein said method comprising:
(a) processing said requests in substantially Async pattern;
(b) structuring said requests with information to enable similar requests to be grouped together;
(c) grouping said similar requests in group session; and
(d) executing said requests in said group session.

2. A method for concurrent information processing according to claim 1 wherein the requests made in substantially Async pattern includes requests made in completely, full or total Async pattern.

3. A method for concurrent information processing according to claim 2 wherein requests is structured such that a plurality of concurrent requests is identifiable by their respective tasks and grouped according to their similarity of task category.

4. A method for concurrent information processing according to claim 3 wherein the information or query structure of the requests is assigned with hash value that is similar according to similarity of task category.

5. A method for concurrent information processing according to claim 3 wherein the grouped requests are executable as a single request.

6. A method for concurrent information processing according to claim 5 wherein the grouped requests are maintained as grouping session for execution in a database server or application server.

7. A method for concurrent information processing according to claim 3 wherein the request is switchable between threads, based on the current holder of the shared data required by the request.

8. A method for concurrent information processing according to claim 3 wherein the information or query structure of the requests is managed on the basis of thread-specific storage structures providing concurrent access to shared data among concurrent data updates.

9. A method for concurrent information processing according to claim 2 wherein the Total-Async pattern includes enabling the requests to pause and restart on demand.

10. A method for concurrent information processing according to claim 2 wherein the threads and requests are de-coupled from each other.

11. A method for concurrent information processing according to claim 2 comprised as a single process with fixed number of threads in different classes.

12. A method for concurrent information processing according to claim 11 wherein incoming requests are handled by Request Handlers and the separate classes of threads are embodied as I/O handlers, taking care of both the network and/or disk I/O.

13. A method for concurrent information processing according to claim 11 wherein one I/O handler runs for each Request Handler and for flushing data as required for secondary storage.

14. A method for concurrent information processing according to claim 5 wherein a new request object is created for the Request Handler to process as a single request for the grouped requests.

15. A method for concurrent information processing according to claim 5 wherein a plurality of sync points for each of the requests in the group is provided prior to their completion.

16. A method for concurrent information processing according to claim 15 wherein all the requests in the group are taken to a predetermined sync point prior before proceeding therefrom and carry forward all of said requests to next synchronization point.

17. A method for concurrent information processing according to claim 2 wherein each processor is bound to a thread group with each core hosting two a thread each for request and I/O handlers.

18. A method for concurrent infatuation processing according to claim 17 wherein each thread group operates on a subset of tables depending on the workload on the database and only the joins access data from other tables.

19. A method for concurrent information processing according to claim 10 wherein in the event a locking request is made, an execution thread shall put up said locking request for queuing without waiting for lock to be acquired and shall then take up another request.

20. A method for concurrent information processing according to claim 19 wherein the request from a first thread is switched to a second thread holding shared data thus enabling said first thread to continue processing the other request.

21. A method for concurrent information processing according to claim 19 implemented in a database server cache wherein in the event a first thread in possession of its own operating page receives a request to operate on said operating page from a second thread, said request is enqueued in said first thread's operating page queue.

22. A method for concurrent infatuation processing according to claim 21 wherein multiple requests from second and subsequent threads are processed in the same manner with each of said multiple requests being so enqueued in said first thread's operating page queue.

23. A method for concurrent information processing according to claim 22 wherein the multiple requests are enqueued in the first thread's operating page queue in the same core.

24. A method for concurrent information processing according to claim 23 wherein the thread or Request Handler takes a lock on the operating pages and the requests enqueued on the page, and said thread groups the enqueued requests according to similarity of tasks whenever possible for group execution.

25. A method for concurrent information processing according to claim 24 comprises executing the grouped requests are executed as a single request or a series of requests in a Grouped Executor Session.

26. A method for concurrent information processing according to claim 1 wherein
(i) a first Request Handler takes a request from Request Handler Group Queue to examine it with a view to execute said request;
(ii) if said request's execution requires access to data or information that is on a particular page of a table, the header of that page is first examined;
(iii) if said particular page is already in possession of a second Request Handler, then said request is queued under one of the queues of said second Request Handler whereby;
(iv) if the page is marked as Operating Page, then said request is queued under Operating Page Queue of said second Request Handler, otherwise said request is queued under Other Page Request Queue; and
(v) said first Request Handler continues by picking up a new request to be examined with a view to execute it.

27. An application server implementing a method according to claim 1.

28. A database server implementing a method according to claim 1.

29. A computer system implementing a method according to claim 1.
